(19) United States
(12) Patent Application Publication
(10) Pub. No.: US 2013/0105395 A1
(43) Pub. Date: May 2, 2013

(54) NANOSTRUCTURED MEMBRANES FOR ENGINEERED OSMOSIS APPLICATIONS

(71) Applicants: McCutcheon Jeffrey R., Tolland, CT (US); Hoek Eric M.V., Pacific Palisades, CA (US); Bui Ngoc, Willington, CT (US); Lind Mary L., Scottsdale, AZ (US)

(72) Inventors: McCutcheon Jeffrey R., Tolland, CT (US); Hoek Eric M.V., Pacific Palisades, CA (US); Bui Ngoc, Willington, CT (US); Lind Mary L., Scottsdale, AZ (US)

(21) Appl. No.: 13/508,892

(22) PCT Filed: Nov. 11, 2010
(86) PCT No.: PCT/US10/56426

§ 371 Date: Dec. 4, 2012

Related U.S. Application Data
(60) Provisional application No. 61/260,365, filed on Nov. 11, 2009.

(51) Int. Cl. B01D 71/68

(52) U.S. Cl. CPC B01D 71/68; B82Y 30/00
USPC 210/654; 210/500.27; 210/500.41; 210/500.38; 210/500.39; 210/500.33; 210/500.25; 427/444; 977/902

(57) ABSTRACT

In one aspect, the invention relates to engineered osmosis and related membrane-based separation technologies. Disclosed are semi-permeable nanostructured osmosis membranes comprising a film polymerized on a nanofiber support fabric, methods for osmotically-driven separation, the method comprising creating an osmotic pressure gradient across a semi-permeable nanostructured osmosis membrane comprising a film polymerized on a nanofiber support fabric, and methods of generating power comprising creating an osmotic pressure gradient across a semi-permeable nanostructured osmosis membrane comprising a film polymerized on a nanofiber support fabric. This abstract is intended as a scanning tool for purposes of searching in the particular art and is not intended to be limiting of the present invention.

### CROSS-REFERENCE TO RELATED APPLICATIONS

This application claims the benefit of U.S. Application No. 61/260,365, filed Nov. 11, 2009, which is hereby incorporated herein by reference in its entirety.

### BACKGROUND

Engineered osmosis (EO) is a membrane-based separation technology with applications to both sustainable energy and water production. EO utilizes energy stored as chemical potential (osmotic pressure) to generate power or drive contaminant removal in water treatment. The lack of membranes with suitable performance (i.e., water flux and solute rejection), acceptable mechanical strength and chemical stability is currently a challenge of membrane technologies used in EO.

Worldwide scarcity of both water and energy are considered grand challenges facing humanity today. These critical commodities are inextricably and reciprocally linked and therefore cannot be considered independently as new technologies are developed to tackle these challenges. Engineered osmosis (EO) is a unique and emerging platform technology that may ultimately help address both water and energy scarcity by enabling the harvesting of low quality energy sources and leveraging them for electricity generation (pressure retarded osmosis, PRO) or water purification (forward osmosis, FO). This sustainable approach to water and energy production has never before been possible through a single platform technology[1, 2].

EO technologies harness osmotic potential energy to drive water across a membrane from a dilute feed solution into a concentrated draw solution. The use of such a non-traditional driving force necessitates the redesign of salt rejecting membranes which have forever been designed for pressure driven operation. As such, traditional thin film composite (TFC) membranes employ an exceeding thin, yet selective barrier layer consisting of highly crosslinked polyamide. The fragile polyamide layer is supported by multiple robust support layers (typically an integral asymmetric polysulfone or polyethersulfone layer cast by phase inversion onto a polyester nonwoven). This TFC membrane design is standard for reverse osmosis (RO) and nanofiltration (NF) applications.

The advent of TFC membranes has led to extensive work in optimization of the complete structure where each layer can be independently (in some cases) tailored for strength, chemistry, pore size, and other properties. In RO, the layer of greatest importance is the selective layer, since it is this layer that primarily determines the membrane permselectivity, while the support layers merely serve to support the membrane during fabrication, handling and operation. Therefore, much effort has been focused on improving the properties of the selective layer (perselectivity and longevity) without much effort focused on the support layer [4-17].

Recent investigations of EO technologies, however, have found that these membranes, which are currently the most common salt rejecting membranes available, are not suitable for EO applications. Though the polyamide layers exhibit the requisite permselectivity, the support structures directly interact with either the feed or draw solution in ways that were unintended. In FO applications, this support structure interacts directly with the driving agent and therefore the effective driving force is critically reduced. In PRO applications, the support layer interacts with the feed solution and thus is susceptible to fouling. In both applications, recent investigations have found that concentration polarization (CP) phenomenon is significantly enhanced by the presence of the support layer. In fact, the polarized layer can occur inside the support layer and thus be enhanced by the lack of mixing and is often referred to as internal concentration polarization. Poor flux performance with traditional TFC membranes has long been attributed to internal CP.

EO development has been impeded by the lack of a well designed membrane that exhibits high water flux, superior selectivity, chemical stability and adequate mechanical strength. A state of the art in membrane research is the invention of TFC polyamide membranes formed by an interfacial polymerization technique for reverse osmosis (RO) [3]. These membranes are basically composed of an ultrathin dense polyamide skin layer and robust support films. By tiering these sub-layers to form asymmetric membranes, it is more flexible to optimize TFC than the classically integral membranes. Though ideal for reverse osmosis processes, the thick support layer in a TFC contributes significant mass transfer resistance by causing internal concentration polarization (ICP). Recent investigations have shown that ICP is a prominent factor causing the substantial water flux decline in osmotically driven membrane processes. Different from external concentration polarization (ECP), the influence of ICP on inhibiting the permeate flow cannot be mitigated by altering hydrodynamic conditions. It has been believed that ICP is mainly affected by the structure parameter, S=tτ/ε, of the porous support layer in which the ICP occurs. This leads to the dependence of ICP on the thickness (t), tortuosity (τ) and the porosity (ε) of the support membrane. Therefore, in order to alleviate this problem, the support layer is necessarily designed to be thin enough and highly porous to decrease t and increase ε respectively. Its chemistry should also be optimized to obtain suitable intrinsic hydrophilicity, tensile strength and chemical stability. Recent achievements in developing high-flux membranes for FO have been intensively reported with tubular [22-24] and flat sheet membranes [25]. Wang et. al. attained well-performed membranes with a FO water flux of 32.2 LMH and small salt flux using self-tailored hollow-fiber-supported TFC membranes [22]. Though it is a promising approach, much endeavor still needs to carry out to reach the urgent demand for water and energy.

Therefore, when conventional TFC-RO membranes are used in FO membrane processes they are prohibitively inefficient because: (i) the hydrophobic character of the support membrane leads to poor wetting and intrinsically low water permeability, (ii) a sponge-like morphology of the support membrane leads to poor mass transfer, which reduces the driving force for water permeation, and (iii) fouling of both the support and active separation layers dramatically reduces water flux.

Thus, there remains a need for membranes and methods of making and using the same that overcome these deficiencies.

### SUMMARY

In accordance with the purpose(s) of the invention, as embodied and broadly described herein, the invention, in one aspect, relates to engineered osmosis and related membrane-based separation technologies.

Disclosed are semi-permeable nanostructured osmosis membranes comprising a film polymerized on a nanofiber support fabric.

Also disclosed are nanostructured osmosis membranes comprising a polymer film and a nanofiber support fabric, and not comprising a macroscale support membrane.

Also disclosed are methods for preparing a semi-permeable nanostructured osmosis membrane, the method comprising polymerizing a film onto a nanofiber support fabric.

Also disclosed are methods for osmotically-driven separation, the method comprising creating an osmotic pressure gradient across a semi-permeable nanostructured osmosis membrane comprising a film polymerized on a nanofiber support fabric.

Also disclosed are methods of generate power comprising creating an osmotic pressure gradient across a semi-permeable nanostructured osmosis membrane comprising a film polymerized on a nanofiber support fabric.

Also disclosed are the products of the disclosed methods.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIGS. 1a-1f are SEM images of the nanofibrous polysulfone support which were electrospun from 25 wt % PSu solutions at a DMF/NMP ratio of (a) 3/7, (b) 5/5, (c) 7/3, (d) 8/2, (e) 9/1 and (f) 10/0. Magnifications: (a) ×1460, (b) ×475, (c) ×485, (d) ×505, (e) ×510, (f) ×485.

FIGS. 2a and 2b are cross-sectional SEM images of CTA commercial membrane magnified at (a) ×250, (b) ×2500.

FIGS. 2c and 2d are cross-sectional SEM images of TFC electrospun porous support. Magnified at (c) ×250, (d) ×32,500.

FIG. 3a is a SEM image of electrospun PES magnified at ×2200.

FIGS. 3b-3D are SEM images of and PES-based TFC polyamide membranes magnified at (b) ×460, (c) ×8850, (d) ×5750. Images (c) and (d) show a “loose” adhesion between polyamide top layer and the polyethersulfone support.

FIGS. 4a-4d are SEM images of PSu-based TFC polyamide membranes magnified at (a) ×220, (b) ×300, (c) ×600, (d) ×10000. Image (b) was viewed from a 90°-angle cross section. The insert in FIG. 4c is an SEM image of electrospun PSu magnified at ×485.

FIG. 5 is a diagram of a cross-linking interaction between polyamide and the bisphenol A group of polysulfone. In this diagram, the curved arrows show the directional tendency of electrons movement.

FIG. 6 is a chart showing the ATR-IR spectrum of porous PES support film (black curve) and PA-coated PES composite membrane (grey curve).

FIG. 7 is a chart showing the ATR-IR spectrum of porous PSu support film (grey curve) and PA-coated PES composite membrane (black curve).

FIGS. 8a-8c are focused ion beam (FIB) images of polysulfone-supported thin film composite polyamide membrane magnified at (a) ×3512, (b and c) ×19995.

FIG. 9 is a schematic diagram of a direct osmosis (DO) system, according to one aspect.

FIG. 10 is a chart showing the water flux through nanofibrous-mat-supported TFC polyamide membranes with PET backing layer (circle), without PET (triangle) and CTA membrane (square) with time. The insert illustrates a clear view for the water flux through TFC polyamide membrane with PET substrates (same as circle curve). (1) Adding 857.14 ml 5M NaCl stock solution into 2 liters of DI water in draw side to achieve a 1.5M NaCl draw solution; (2) adding 20.0 ml 100 mM SDS stock solution into feed side to obtain a 1 mM SDS solution in feed. Experimental conditions: run in PRO mode; draw solution contained 1.5M NaCl; feed solution was deionized water; crossflow velocity of the feed and draw solution were 0.6 and 0.9 LPM, respectively; temperature of both feed and draw solutions was 23±1° C. Note that a water flux of 1 lm⁻²h⁻¹ (LMH) corresponds to 1.698 galft⁻²day⁻¹ (GFD).

FIG. 11 is a chart showing the average water flux and reverse salt leakage through the nanofibrous-mat-supported TFC polyamide membranes with and without PET backing layer in direct osmosis tests with the assistance of wetting agent SDS.

FIG. 12 is a diagram of a probable arrangement of hydrogen-bonding hydration of polar polyamide in the presence of SDS surfactant.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. DEFINITIONS

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a composition,” “a fiber,” or “a step” includes mixtures of two or more such functional compositions, fibers, steps, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

As used herein, the terms “optional” or “optionally” means that the subsequently described event or circumstance can or can not occur, and that the description includes instances where said event or circumstance occurs and instances where it does not.

As used herein, the terms “effective amount” and “amount effective” refer to an amount that is sufficient to achieve the desired result or to have an effect on an undesired condition.

The term “stable,” as used herein, refers to compositions that are not substantially altered when subjected to conditions to allow for their production, detection, and, in certain aspects, their recovery, purification, and use for one or more of the purposes disclosed herein.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “homopolymer” refers to a polymer formed from a single type of repeating unit (monomer residue).

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “segmented polymer” refers to a polymer having two or more chemically different sections of a polymer backbone that provide separate and distinct properties. These two sections may or may not phase separate. A “crystalline” material is one that has ordered domains (i.e., aligned molecules in a closely packed matrix), as evidenced by Differential Scanning calorimetry, without a mechanical force being applied. A “noncrystalline” material is one that is amorphous at ambient temperature. A “crystallizing” material is one that forms ordered domains without a mechanical force being applied. A “noncrystallizing” material is one that forms amorphous domains and/or glassy domains in the polymer at ambient temperature.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. REVERSE OSMOSIS AND NANOFILTRATION MEMBRANES

Reverse osmosis membranes and nanofiltration membranes can be used to separate dissolved or dispersed materials from feed streams. The separation process typically involves bringing an aqueous feed solution into contact with one surface of the membrane under pressure so as to effect permeation of the aqueous phase through the membrane while permeation of the dissolved or dispersed materials is prevented.

Both reverse osmosis and nanofiltration membranes typically include a thin film discriminating layer fixed to a porous support, collectively referred to as a “composite membrane.” Ultrafiltration and microfiltration membranes may also have a composite arrangement. The support provides physical strength but offers little resistance to flow due to its porosity. On the other hand, the discriminating layer can be less porous and can provide the primary means of separation of dissolved or dispersed materials. Therefore, it is generally the discriminating layer which determines a given membrane's “rejection rate”—the percentage of the particular dissolved material (i.e., solute) rejected, and “flux”—the flow rate per unit area at which the solvent passes through the membrane.

Reverse osmosis membranes and nanofiltration membranes vary from each other with respect to their degree of permeability to different ions and organic compounds. Reverse osmosis membranes are relatively impermeable to virtually all ions, including sodium and chloride ions, as well as uncharged solutes with molecular weights above about 200 Daltons. Therefore, reverse osmosis membranes are widely used for the desalination of brackish water or seawater to provide a highly purified water for industrial, commercial, or domestic use because the rejection rate of sodium and chlorine ions for reverse osmosis membranes is usually greater than about 90 percent.

Conventional nanofiltration membranes are more specific for the rejection of ions. Generally, nanofiltration membranes reject divalent ions, including radium, magnesium, calcium, sulfate, and carbonate. In addition, nanofiltration membranes are generally impermeable to organic compounds having molecular weights above about 1,000 Daltons. Additionally, nanofiltration membranes generally have higher fluxes at comparable pressures than reverse osmosis membranes. These characteristics render nanofiltration membranes useful in such diverse applications as the “softening” of water and the removal of pesticides from water. As an example, nanofiltration membranes generally have a sodium chloride rejection rate of from about 0 to about 50 percent but can reject salts such as magnesium sulfate from about 50 to about 99 percent.

Among particularly useful membranes for reverse osmosis and nanofiltration applications are those in which the discriminating layer is a polyamide. The polyamide discriminating layer for reverse osmosis membranes is often obtained by an interfacial polycondensation reaction between a polyfunctional amine monomer and a polyfunctional acyl halide monomer (also referred to as a polyfunctional acid halide) as described in, for example, U.S. Pat. No. 4,277,344. The polyamide discriminating layer for nanofiltration membranes is typically obtained via an interfacial polymerization between a piperazine or an amine substituted piperidine or cyclohexane and a polyfunctional acyl halide as described in U.S. Pat. Nos. 4,769,148 and 4,859,384. Another way of obtaining polyamide discriminating layers suitable for nanofiltration is via the methods described in, for example, U.S. Pat. Nos. 4,765,897; 4,812,270; and 4,824,574. These patents describe changing a reverse osmosis membrane, such as those of U.S. Pat. No. 4,277,344, into a nanofiltration membrane.

Composite polyamide membranes are typically prepared by coating a porous support with a polyfunctional amine monomer, most commonly coated from an aqueous solution. Although water is a preferred solvent, non-aqueous solvents may be utilized, such as acetyl nitrile and dimethylformamide (DMF). A polyfunctional acyl halide monomer (also referred to as acid halide) is subsequently coated on the support, typically from an organic solution. Although no specific order of addition is necessarily required, the amine solution is typically coated first on the porous support followed by the acyl halide solution. Although one or both of the polyfunctional amine and acyl halide may be applied to the porous support from a solution, they may alternatively be applied by other means such as by vapor deposition, or neat.

Means for improving the performance of membranes by the addition of constituents to the amine and/or acyl halide solutions are described in the literature. For example, U.S. Pat. No. 4,950,404, issued to Chau, describes a method for increasing flux of a composite membrane by adding a polar aprotic solvent and an optional acid acceptor to the aqueous amine solution prior to interfacially polymerizing the amine with a polycarboxylic acid halide. Similarly, U.S. Pat. Nos. 6,024,873; 5,989,426; 5,843,351; 5,733,602; 5,614,099; and 5,576,057 to Hirose et al. describe the addition of selected alcohols, ethers, ketones, esters, halogenated hydrocarbons, nitrogen-containing compounds and sulfur-containing compounds having a solubility parameter of 8 to 14 (cal/cm³)^{1/2} to the aqueous amine solution and/or organic acid halide solution prior to interfacial polymerization.

Methods of improving membrane performance by post-treatment are also known. For example, U.S. Pat. No. 5,876,602 to Jons et al. describes treating a polyamide composite membrane with an aqueous chlorinating agent to improve flux, lower salt passage, and/or increase membrane stability to base. U.S. Pat. No. 5,755,964 to Mickols discloses a process wherein the polyamide discriminating layer is treated with ammonia or selected amines, e.g., butylamine, cyclohexylamine, and 1,6 hexane diamine. U.S. Pat. No. 4,765,897 to Cadotte discloses the post treatment of a membrane with a strong mineral acid followed by treatment with a rejection enhancing agent.

### C. SEMI-PERMEABLE NANOSTRUCTURED OSMOSIS MEMBRANES

In one aspect, the invention relates to membranes for use in osmotically-driven separations having applications ranging from forward osmosis water purification, osmotic water samplers, food and beverage dehydration, and salinity gradient energy production. In one aspect, the invention relates to a semi-permeable nanostructured osmosis membrane comprising a film polymerized on a nanofiber support fabric. In a further aspect, the invention relates to a nanostructured osmosis membrane comprising a polymer film and a nanofiber support fabric, and not comprising a macroscale support membrane.

It is understood that the disclosed compositions, mixtures, and membranes can be employed in connection with the disclosed methods and uses.

1. Fabrics

In one aspect, the disclosed semi-permeable nanostructured osmosis membranes comprising a nanofiber support fabric.

a. Composition

In one aspect, the nanofiber support fabric can comprise polyethersulfone (PES). In a further aspect, the nanofiber support fabric can comprise polysulfone (PSu). In a further aspect, the nanofiber support fabric can comprise PES and PSu.

In one aspect, the nanofiber support fabric can be an electrospun fabric. In a further aspect, the nanofiber support fabric can be a nonwoven fabric. In one aspect, the nanofiber support fabric can comprise nonwoven, electrospun PES. In a further aspect, the nanofiber support fabric can comprise nonwoven, electrospun PSu. For example, in one aspect, the electrospun fiber is spun directly onto a polyester (PET) nonwoven support. These nonwovens, which often serve as structural supports for reverse osmosis membranes, are mechanically strong and therefore facilitate handling of the electrospun nowoven after fabrication.

In another aspect, the PET support used can be varied based upon the end application. As an example, thinner, more porous PET nonwovens can be employed for FO applications while less porous PET may be required for high pressure conditions (such as in PRO)

In yet another aspect, the PET support may be removed before or after the interfacial polymerization of the polyamide layer. This “sacrificial” PET layer can then be discarded or reused. In yet another approach the PET support can be retained on the final membrane for additional support.

b. Electrospinning

The technique of electrospinning, also known within the fiber forming industry as electrostatic spinning, of liquids and/or solutions capable of forming fibers, is well known and has been described in a number of patents as well as in the general literature.

Typically, the process of electrospinning generally involves the creation of an electrical field at the surface of a liquid. Fibers produced by this process have been used in a wide variety of applications, and are known, from U.S. Pat. Nos. 4,043,331 and 4,878,908, to be particularly useful in forming non-woven structures. The resulting electrical forces create a jet of liquid which carries electrical charge. Thus, the liquid jets maybe attracted to other electrically charged objects at a suitable electrical potential. As the jet of liquid elongates and travels, it will harden and dry. The hardening and drying of the elongated jet of liquid may be caused by cooling of the liquid, i.e., where the liquid is normally a solid at room temperature; evaporation of a solvent, e.g., by dehydration, (physically induced hardening); or by a curing mechanism (chemically induced hardening). The produced fibers are collected on a suitably located, oppositely charged receiver and subsequently removed from it as needed, or directly applied to an oppositely charged generalized target area.

In one aspect, electrospinning (ES) is an atomization process of fluid which exploits the interactions between an electrostatic field and the fluid. In one aspect, the fluid can be a conducting fluid. During electrospinning, fibers with micron or sub-micron sized diameters are extruded be means of an electrostatic potential from a polymer solution (see U.S. Pat. No. 1,975,504 to Formhals). When an external electrostatic field is applied to a fluid (e.g., a semi-dilute polymer solution or a polymer melt), a suspended conical droplet is in equilibrium with the electric field. Electrostatic atomization occurs when the electrostatic field is strong enough to overcome the surface tension of the liquid. The liquid droplet then becomes unstable and a tiny jet is ejected from the surface of the droplet. As it reaches a grounded target, the material can be collected as an interconnected web containing relatively fine, i.e. small diameter, fibers. The resulting films (or membranes) from these small diameter fibers have very large surface area to volume ratios and small pore sizes. This process typically yields non-woven mats or felts composed of round fibers that are extremely pliable. Due to their high-surface area and good mechanical characteristics, electrospun meshes have traditionally found applications in filtration and composite reinforcement. For the very same reasons, felts and meshes derived from biocompatible polymers such as poly(lactic acid) and its copolymer with glycolic acid and other polyesters are being explored as substrates (scaffolds) for association of cells in the engineering of tissue (see Kenawy et al., Biomaterials, 2003, 24 (6), 907 describing making a fiber by electrospinning process from a single-phase system containing ethylene vinyl alcohol, 70% propanol and 30% water).

Depending on the modulus of the polymer, fibers ranging from cylindrical, porous to flat-ribbon like can be obtained. The diameters of electrospun fibers can be modulated by changing polymer concentration or solvent systems. Fiber diameter is typically controlled by changing electric field strength (either by changing applied voltage or tip-to-target distance), changing evaporation rates (via changing the spinning environment or using solvents of different volatilities), or by changing polymer concentration. The last method enjoys particular popularity among researchers, since polymer concentration is an easy variable to control and can have repeatable and drastic effects on fiber diameters. This method works by changing both the amount of solvent that must evaporate before a solid fiber precipitates from the solution and by changing the viscosity of the solution, and hence, “Taylor cone” formation and final jet diameter.

In conventional methods, surface geometry and morphology of electrospun nanofibers has been more difficult to modify. Typical electrospun fibers adopt a circular cross-section, though porous and flat fiber morphologies have been observed in several polymer/solvent systems, but little research has found success at controlling these morphologies. Common techniques used to modify fiber cross-sectional shape have been to cospin polymers and selectively remove certain polymer phases. More recent approaches have succeeded in producing hollow fiber morphologies by using an immiscible second phase and coaxial spinnerets. Both techniques involve either complicated processing steps or specialized electrospinning apparatus to achieve the desired final shape.

2. Films

In one aspect, the membranes of the invention can comprise a film comprising a polymer matrix, wherein the film is substantially permeable to water and substantially impermeable to impurities. By “polymer matrix” it is meant that the polymeric material can comprise a three-dimensional polymer network. For example, the polymer network can be a crosslinked polymer formed from reaction of at least one polyfunctional monomer with a difunctional or polyfunctional monomer.

a. Polymer Composition

While it is contemplated that the polymer matrix can comprise any three-dimensional polymer network known to those of skill in the art, in one aspect, the film comprises at least one of an aliphatic or aromatic polyamide, aromatic polyhydrazide, poly-bensimidazolone, polyepiamine/amide, polyepiamine/urea, poly-ethyleneimine/urea, sulfonated polyfurane, polybenzimidazole, polypiperazine isophtalamide, a polyether, a polyether-urea, a polyester, or a polyimide or a copolymer thereof or a mixture thereof. Typically, the polymer is selected to be a polymer that can be formed by an interfacial polymerization reaction or a polymer that can be crosslinked subsequent to polymerization.

In one aspect, the film comprises at least one of a polyamide, a polyether, a polyether-urea, a polyester, or a polyimide. In a further aspect, the film comprises at least one of a polyamide, a polyether, a polyether-urea, a polyester, a polyimide, or a copolymer thereof. In a further aspect, the film comprises at least one of a polyamide, a polyether, a polyether-urea, a polyester, a polyimide, a copolymer thereof, or a mixture thereof.

In a further aspect, the film comprises a polyamide. The polyamide can be an aromatic polyamide or a non-aromatic polyamide. For example, the polyamide can comprise residues of a phthaloyl (e.g., isophthaloyl or terephthaloyl) halide, a trimesyl halide, or a mixture thereof. In another example, the polyamide can comprise residues of diaminobenzene, triaminobenzene, polyetherimine, piperazine or poly-piperazine or a mixture thereof. In a further aspect, the film comprises residues of a trimesoyl halide and residues of a diaminobenzene. In a further aspect, the film comprises residues of trimesoyl chloride and m-phenylenediamine. In a further aspect, the film comprises the reaction product of trimesoyl chloride and m-phenylenediamine.

In one aspect, the polyamide can comprise an aromatic polyamide. In a further aspect, the film comprises an interfacially polymerized aromatic polyamide. In a further aspect, the film comprises an aromatic polyamide interfacially polymerized onto a nonwoven, electrospun polyethersulfone nanofiber support fabric.

b. Film Thickness

While the polymer film can be provided at any desired film thickness, the films of the invention are, in one aspect, provided at a thickness of from about 1 nm to about 1000 nm. For example, the film can be provided at a thickness of from about 10 nm to about 1000 nm, from about 100 nm to about 1000 nm, from about 1 nm to about 500 nm, from about 10 nm to about 500 nm, from about 50 nm to about 500 nm, from about 50 nm to about 200 nm, from about 50 nm to about 250 nm, from about 50 nm to about 300 nm, or from about 200 nm to about 300 nm.

In a further aspect, the thickness of the film layer can be selected to match the particle size of the nanoparticles. For example, for nanoparticles having an average hydrodynamic diameter of from about 200 nm to about 300 nm, the film thickness can be selected to have a film thickness of from about 200 nm to about 300 nm. As another example, for nanoparticles having an average hydrodynamic diameter of from about 50 nm to about 200 nm, the film thickness can be selected to have a film thickness of from about 50 nm to about 200 nm. As another example, for nanoparticles having an average hydrodynamic diameter of from about 1 nm to about 100 nm, the film thickness can be selected to have a film thickness of from about 1 nm to about 100 nm.

In one aspect, the film can have an average thickness of from about 50 nm to about 500 nm, from about 200 nm to about 300 nm, or from about 50 nm to about 200 nm.

The film thickness can be visually confirmed and quantified, for example, by using transmission electron microscopy (TEM). Freger V, Gilron J, Belfer S, “TFC polyamide membranes modified by grafting of hydrophilic polymers: an FT-IR/AFM/TEM study,” Journal of Membrane Science 209 (2002) 283-292.

c. Properties

In various aspects, the disclosed membranes can have various properties that provide the superior function of the membranes, including excellent flux, high hydrophilicity, negative zeta potential, surface smoothness, an excellent rejection rate, improved resistance to fouling, and the ability to be provided in various shapes. It is also understood that the membranes have other properties.

d. Particles

In one aspect, the film and/or the nanofiber support fabric can comprise particles. In a further aspect, the film and/or the nanofiber support fabric can comprise nanoparticles. In an example, the nanoparticles can be hydrophilic nanoparticles. In a further aspect, the nanoparticles can comprise preferential flow paths.

In one aspect, the nanoparticles can have an average hydrodynamic diameter of from about 10 nm to about 1000 nm, from about 50 nm to about 500 nm, from about 50 nm to about 200 nm, or from about 200 nm to about 300 nm.

In one aspect, the nanoparticles can comprise a mesoporous molecular sieve comprising at least one of an oxide of aluminum, titanium or silicon, an aluminosilicate, titanosilicate or an aluminophosphate or a mixture thereof.

In one aspect, the nanoparticles can comprise at least one zeolite. For example, the nanoparticles can comprise Zeolite A.

### D. METHODS FOR PREPARING SEMI-PERMEABLE NANOSTRUCTURED OSMOSIS MEMBRANES

In one aspect, the invention relates to a method for preparing a semi-permeable nanostructured osmosis membrane, the method comprising polymerizing a film onto a nanofiber support fabric. In one example, polymerizing can be performed interfacially.

In one aspect, the nanofiber support fabric comprises polyethersulfone. The nanofiber support fabric can be electrospun, according to one aspect. In a further aspect, the nanofiber support fabric can be nonwoven. In one aspect, the film comprises a polyamide. In a further aspect, the film comprises at least one of a polyamide, a polyether, a polyether-urea, a polyester, or a polyimide or a copolymer thereof or a mixture thereof.

More specific methods of fabrication are described in the experimental section.

### E. METHODS FOR USING SEMI-PERMEABLE NANOSTRUCTURED OSMOSIS MEMBRANES

In one aspect, the invention relates to a method for osmotically-driven separation, the method comprising creating an osmotic pressure gradient across a semi-permeable nanostructured osmosis membrane comprising a film polymerized on a nanofiber support fabric.

In one aspect, the semi-permeable nanostructured osmosis membrane can exhibit a water permeability of about 2 times, 3 times, 4 times, 5 times, 6 times, 7 times, 8 times, 9 times, 10 times, 20 times, 30 times, 40 times, 50 times, 60 times, 70 times, 80 times, 90 times, 100 times, 110 times, 120 times about 130 times, 140 times, 150 times, 160 times, 170 times, 180 times, 190 times, 200 times, or more than about 200 times that of a commercial “CTA” membrane. In a further aspect, the semi-permeable nanostructured osmosis membrane exhibits a salt passage of about 2 times, 3 times, 4 times, 5 times, 6 times, 7 times, 8 times, 9 times, 10 times, 20 times, 30 times, 40 times, 50 times, 60 times, 70 times, 80 times, 90 times, 100 times, 110 times, 120 times about 130 times, 140 times, 150 times, 160 times, 170 times, 180 times, 190 times, 200 times, or more than about 200 times that of a commercial “CTA” membrane.

In one aspect, the method for osmotically-driven separation can produce purified water. In a further aspect, the method for osmotically-driven separation can produce electricity.

It is understood that the product produced by any of the disclosed methods or processes is also disclosed. Further, it is understood that the disclosed processes can be employed in connection with the disclosed fabrics, films and particles.

### F. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Materials

Polyethersulfone (PES, RADEL H-3000, M_{w}=7.8×10⁴ g/mol, Mₙ=2.5×10⁴ g/mol) and polysulfone (PSu, UDEL P-3500, M_{w}=8.0×10⁴-8.6×10⁴ g/mol, Mₙ=2.3×10⁴ g/mol) were provided by Solvay Advanced Polymers. Polyester nonwoven fabric (PET, FO 2425 N/30) sheet was obtained from Ahlstrom (Helsinki, Finland). Commercial asymmetric cellulose triacetate forward osmosis membranes (CTA) were acquired from Hydration Technology Inc. (HTI, Albany, Oreg.) for comparison. N,N-Dimethylformamide (DMF, anhydrous, 99.8%), N-Methyl-2-pyrrolidone (NMP, anhydrous, 99.5%), 1,3,5-Benzenetricarbonyl trichloride (TMC, 98%), m-Phenylenediamine (MPD, >99%), sodium bisulfite (NaHSO₃, A.C.S. reagent), sodium hypochlorite (NaOCl, solution, available chlorine 10-15%) were obtained from Sigma Aldrich. Sodium dodecyl sulfate (SDS, 99%) was provided by Fisher Scientific. Isopar-G, referred to hereafter as “isopar”, was supplied by Gallade Chemical. All chemicals were used as received without further treatment. For the direct osmosis tests, sodium chloride (NaCl, crystalline, certified ACS, Fisher Scientific) and deionized water from a Millipore Integral 10 water system (Millipore, USA) were used.

2. Fabrication of the Nonwoven Porous Support Layers Using Electrospinning Technique

Homogeneous solutions of 25% (by weight) of PSu and 20% PES in bi-solvent systems of DMF and NMP at various solvent ratios were separately prepared by stirring at 60° C. in 8 hours. PES was used in this study to have a fundamental comparison with PSu in the formation of TFC polyamide membrane. Therefore, only one solvent ratio which is relevant to the optimal ratio used in preparing PSu-based supports was used for preparing PES solution. These polymeric dopes were further slowly stirred at room temperature over night prior to being spun.

The as-prepared polymeric solutions were electrospun onto a PET nonwoven scaffold under a high voltage field of 27.5 kV with a distance between the spinneret and the rotating drum collector of 16 cm. The experiments were operated at 25° C. in a 10% RH atmosphere. The flow rate was set at 0.9 ml/h. After being collected on the rotating drum, a mat of the electrospun nanofibers was taken off and put into the vacuum oven at 70° C. in order to release the residue solvent out of the sample. The dried electrospun non-woven nanofibers mat was then coated with a polyamide selective layer via interfacial polymerization.

3. Fabrication of Polyamide Top Layer of the Thin Film Composite Membrane Via Interfacial Polymerization

The PSu support membranes were first immersed in an aqueous solution of 3.4 wt % MPD for 120 s. Excess MPD solution was removed from the support membrane surface using an air knife. The membrane was then dipped into a solution of 0.15 wt % TMC in isopar for 60 s to form an ultrathin polyamide film. The post-treatment steps for the composite membrane included thermally treating with DI water at 95° C. for 120 s, rinsing with 200 ppm NaOCl and 1000 ppm NaHSO₃ aqueous solutions at ambient temperature for 120 s and 30 s, respectively, and heat-curing again with DI water at 95° C. for 120 s. The as-prepared TFC polyamide membrane was eventually stored in DI water at 4° C.

4. Membrane Characterization

Surface morphology and cross-sectional structure of the electrospun supports and the TFC polyamide membranes were qualitatively evaluated with scanning electron microscopy (SEM) technique. A cold cathode field emission scanning electron microscope JSM-6335F and a FEI Phenom desktop SEM (FEI Company, USA) were used for imaging. A CAM 101 series contact angle goniometer was used to measure the contact angle of the electrospun nonwoven substrates. Attenuated total reflection Fourier-transform infrared (ATR-FTIR) spectroscopy was used to prove for the successful coating of the polyamide skin layer on the top of the nonwoven PES/PSu support by the in-situ interfacial polycondensation process. Spectra were taken in a (FT/IR 670 plus; Jasco, Easton, Md.) with a variable angle attenuated total reflection (ATR) attachment coupled to a germanium crystal operated at 45 degrees in an argon environment. Furthermore, focused ion beam (FIB) characterization on the PSU-based TFC polyamide membrane was conducted to indicate the extremely high interfacial area between the polyamide skin layer and the electrospun support due to its exceptionally high surface area. This analysis was carried out using a FEI Strata 400 STEM DualBeam system which combines the Field Emission Scanning Electron Microscope (FE-SEM) with Focused Ion Beam (FIB) technology and Flipstage/STEM assembly. By scanning the sample with a gallium ion beam, a selected area of polyamide was “peeled off” and the interface between PA skin layer and its PSu support was observed.

5. Membrane Separation Performance in Direct Osmosis (DO) System

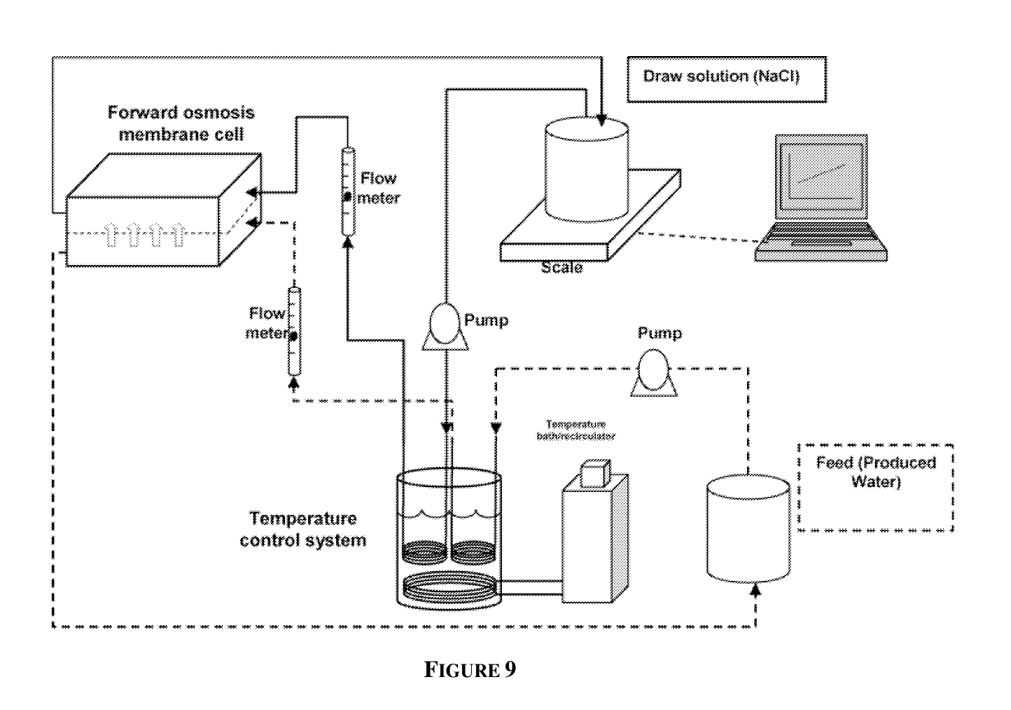

Osmotically driven water flux and reverse salt leakage through electrospun-PSu-based TFC membranes with and without PET support layers were characterized using lab-scale direct osmosis (DO) crossflow system, as depicted in FIG. 9. The crossflow permeation cell was custom built with rectangular channels on both sides of the membrane with dimensions of 74 mm long by 25 mm wide by 2.5 mm deep. Mesh spacers were inserted within both channels as supports. 1.5M sodium chloride solution was used as the draw solution to form an osmotic pressure of 75.1 atm and drive the water transport through the membrane while DI water was used as the feed solution. The liquids were pumped in a closed loop using variable speed gear pumps (Cole Parmer, USA). The flow velocities at the feed and draw sides were 0.6 and 0.9 liter per minute (LPM), respectively. The temperatures of the feed and draw solutions were maintained at 23±1° C. using a recirculating water bath and a heat exchanger. The feed solution was placed on a scale (Denver Instruments, Denver, Colo.) and weight changes were recorded over time to determine the water flux. Conductivities of the liquids were also measure at given points to estimate the reverse salt leakage through the membrane. The concentrations of the feed solution were interpolated from an empirical conductivity-concentration curve of NaCl dilute solutions.

The DO tests were carried out in the pressure-retarded osmosis (PRO) orientation in which the membrane active layer faces the draw solution. The system was first run with DI water on both sides of the membrane to reach temperature stability. Concentrated NaCl (5M) stock solution was then added into the draw side to establish a desired 1.5M NaCl solution and the flux was measured. 60 min after the addition of NaCl to the draw solution, an appropriate amount of 100 mM sodium dodecyl sulfate (SDS) aqueous stock solution was added into the feed solution to bring its concentration to 1 mM SDS. As proved in McCutcheon et. al., hydrophobicity of the support layer remarkably hinders water flux in osmotically driven membrane processes. The pathways for water transport are, hence, reduced due to the severe internal concentration polarization phenomena and the discontinuity of water within the membrane. Improved wetting of the support layer is, therefore, critical to improving flux performance of membrane in direct osmosis, especially in PRO applications with dilute feed solutions [17]. From this perspective, SDS was exploited to improve the water flux through the TFC polyamide membranes supported by hydrophobic polymeric scaffolds.

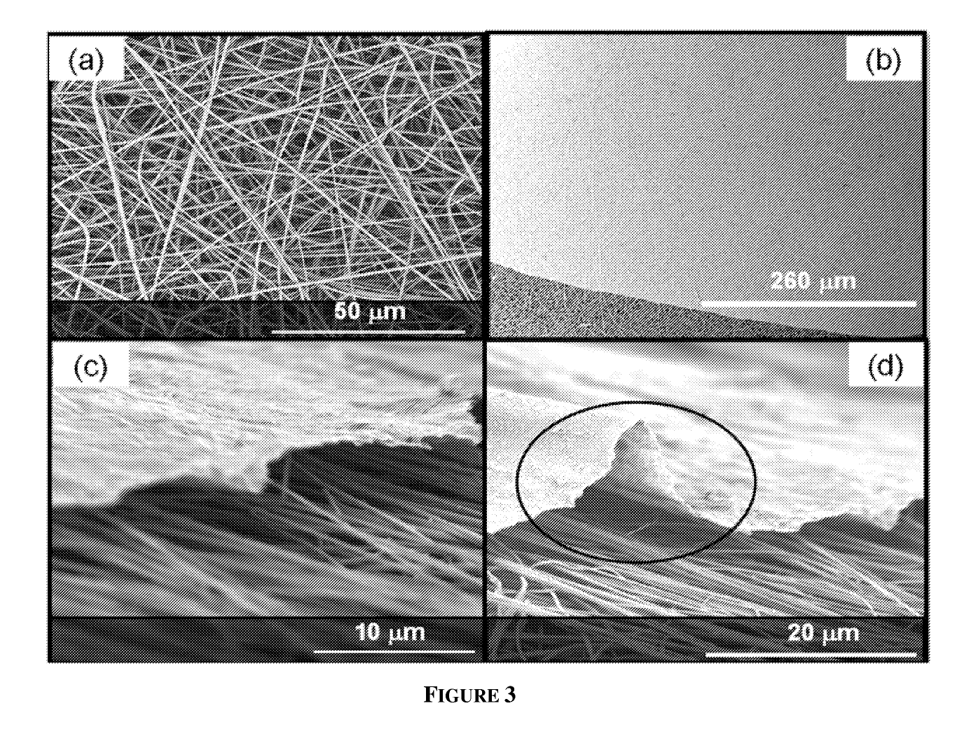

Though the PET nonwoven supports the whole membrane mechanically, it can, in certain aspects, contribute to mass transfer resistance in EO applications. The PET can, in certain aspects, noticeably contribute to the severe internal concentration polarization. Thus, the PET was carefully removed from the new TFC membranes. These membrane are referred to WithPET and NoPET samples hereafter. Separation performance was tested in forward osmosis mode using magnesium sulfate as the concentrated osmotic draw solution. Hand-cast membrane were benchmarked against a commercial osmotic membrane designated as “CTA” by Hydration Technologies Inc. (HTI). Two NS-TFC membranes were tested. In one, the electrospun nanofiber support was spun direction only a polyester (PET) nonwoven support. The membranes were tested both with and without this support. In the membranes tested without the PET support, the PET was removed after interfacial polymerization. As shown in FIG. 3, first generation NS-TFC membranes with the PET layer exhibited ˜3 times higher water permeability through the membrane and lower salt flux (higher rejection). The membrane with the PET layer removed exhibited ˜10 times higher flux, but significantly higher salt rejection. Without wishing to be bound by theory, it is believed that this is likely due to defects formed on the surface during the PET removal step. Low selectivity osmotic membranes do not preclude their use in some applications, like PRO that require high flux but not high selectivity.

6. Results

a. Characteristics of the Polymeric Support Layers

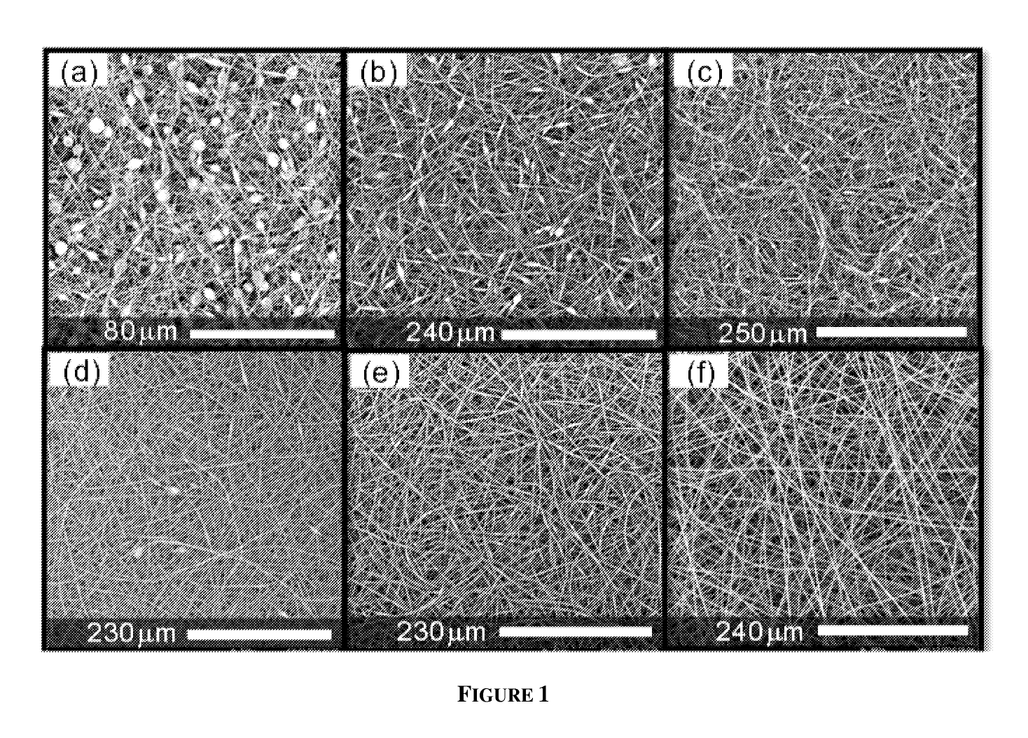

The ratio of DMF and NMP solvents was adjusted in a suitable range to obtain reasonable adhesion between the electrospun nonwoven mid-layer and the PET backing layer and to achieve desirable nanofibers structure. This ratio can affect the morphology of fibers as well as the wetness of the nanofibers support. In certain aspects, it can be important that the fibers deposit onto the PET while still wet enough to enable soldering of the fiber junctions. These junctions in turn help to increase the mechanical strength of fibers mat. FIG. 1 shows differently morphological nanofibers spun onto the PET scaffold from solutions of PSu with various solvent systems. The average diameter of these nanofibers is about 250 nm. A large number of beads and microspheres appeared in the PSu support derived from solution with 30% DMF in the solvent system with NMP. Avoiding the appearance of beads in electrospun nanofibers mat can help to achieve firm supports with good uniformity in porosity and fibers size and shape.

By gradually increasing the partition of DMF to 50%, 70%, 80%, 90% and 100%, the fibers became smooth and continuous with an apparent decrease of beads and defects. However, as discussed in [26], the high vapor pressure of DMF at 25° C. (3.85 mmHg) can lead to fast evaporation during the electrospinning process.

Excessive evaporation can affect the fiber deposition process (e.g., nanofibers depositing on the PET backing layer can be overdried, thus decreasing opportunity for well-adhered fibers). Low adhesion can, therefore, lead to low quality TFC membranes in terms of mechanical strength and firmness. NMP, which has lower vapor pressure (0.5 mmHg at 25° C.), was therefore used to mix with DMF to decelerate the evaporation rate [26]. Thus, in certain examples, the ratio of 70% DMF and 30% NMP was selected for polysulfone and polyethersulfone nanofiber supports for TFC membranes.

b. Characterization of Thin Film Composite Membrane—Imaging with Scanning Electron Microscopy

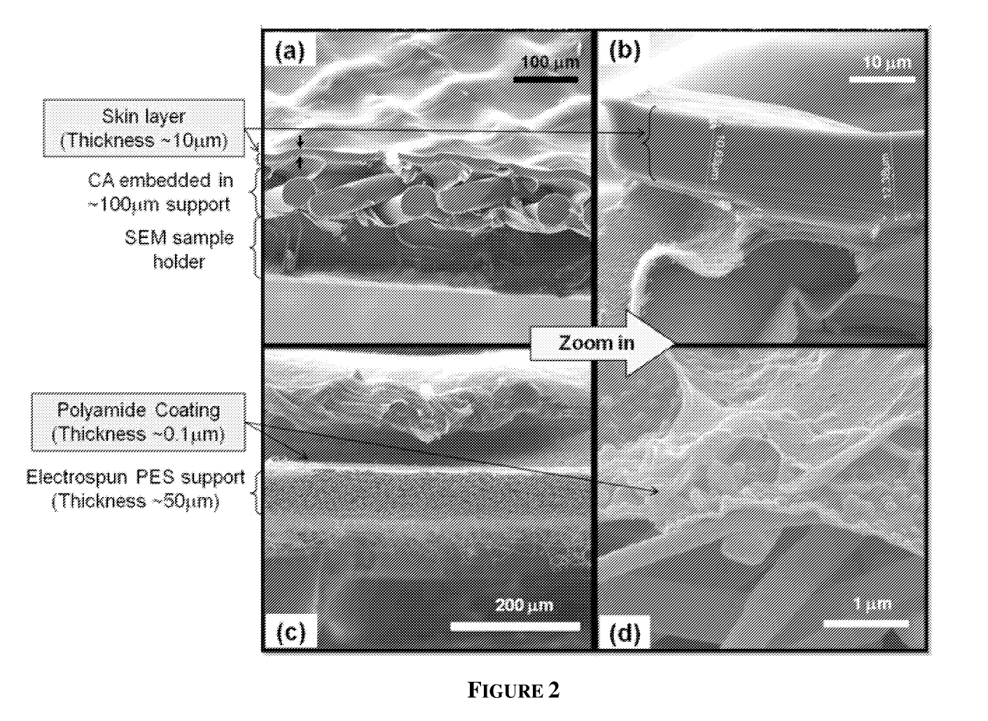

Cross-sectional SEM images in FIG. 2 give a basic comparison in thickness and porosity of CTA membranes obtained from HTI (a & b) and electrospun fibers supported TFC polyamide membranes (c & d). It has been shown, in this figure, that the thicknesses of both the support and the active layers in lab-made TFC are typically much thinner than those of the commercial cellulose acetate TFC membrane. Therefore, the thin nanofibers nonwoven support with high porosity and low tortuosity is expected to alleviate the severity of internal concentration polarization by affecting the mass transfer coefficient in the vicinity of the interface of the active layer.

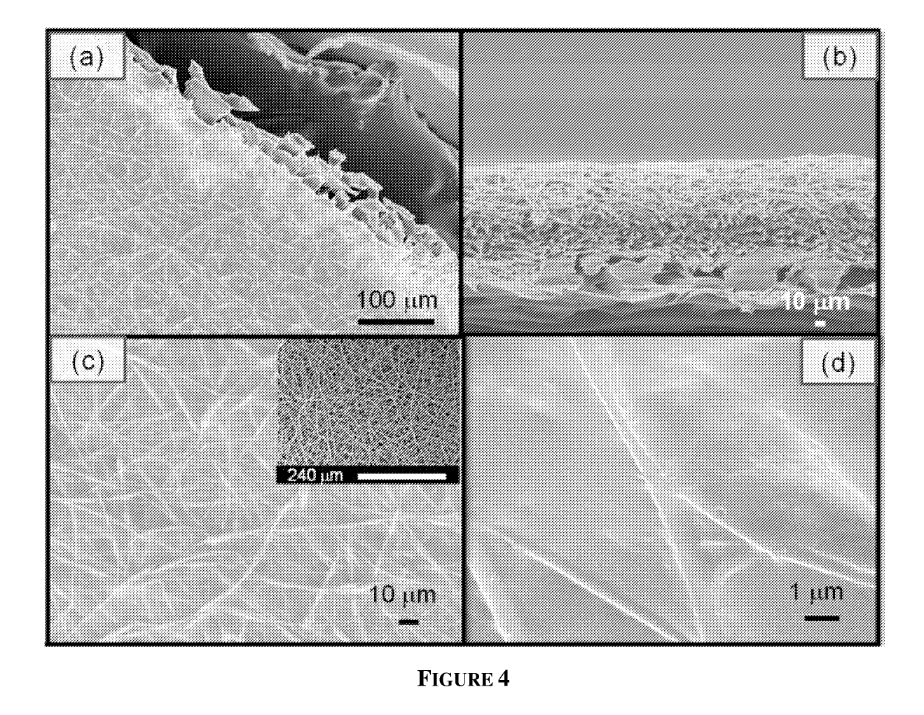

SEM images of PES-supported TFC were illustrated in FIG. 3. The polyamide was well coated on the top of the PES substrate. However, the adhesion between this selective layer and its support appeared poor as displayed in FIG. 3 (c & d). The PA film delaminated readily from the PES support and in some cases was prone to folding up and slide on the PES support. The PA film behaved differently on the PSu substrate (FIG. 4). Here, the PSu fibers clearly imprint onto the PA layer, indicating a tighter bonding between the two layers. In some cases, the PA layer wraps around the PSu fibers.

Without wishing to be bound by theory, it is believed that this reproducible result is due to the chemistry differences between the PSu and PES. These differences can result in physical affinity and/or chemical interaction between the polysulfone or polyethersulfone and the polyamide layers. The former can be dependent on the hydrophilicity of the support polymers. Since PES and PSu substrates were first brought into contact with the aqueous MPD solution in the interfacial polymerization step, their hydrophilicity plays a role in the spread of MPD solution as well as the depth of diffusion of MPD molecules on the surface of these supports. The reaction zone between MPD and TMC is, therefore, affected by this physical property of polymers. However, measurements on the electrospun PES and PSu supports revealed insignificant differences in their water contact angles. They both fell in the range of 120° to 140°. Therefore, a slight difference in hydrophilicity between PES and PSu is believed to be a small contributor in their behavior at the interface with polyamide. Rather, a chemical difference between PSu and PES is the bisphenol A moiety, as illustrated in Table 1:

TABLE 1
MOLECULAR STRUCTURES OF POLYETHERSULFONE AND POLYSULFONE

| Polymer | Molecular structure |
|---|---|
| Polyethersulfone (PES) | 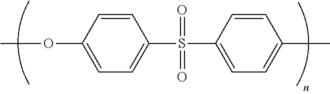 |
| Polysulfone (PSu) | 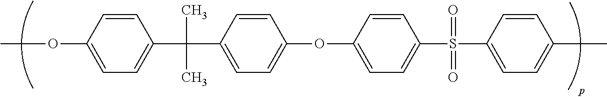 |

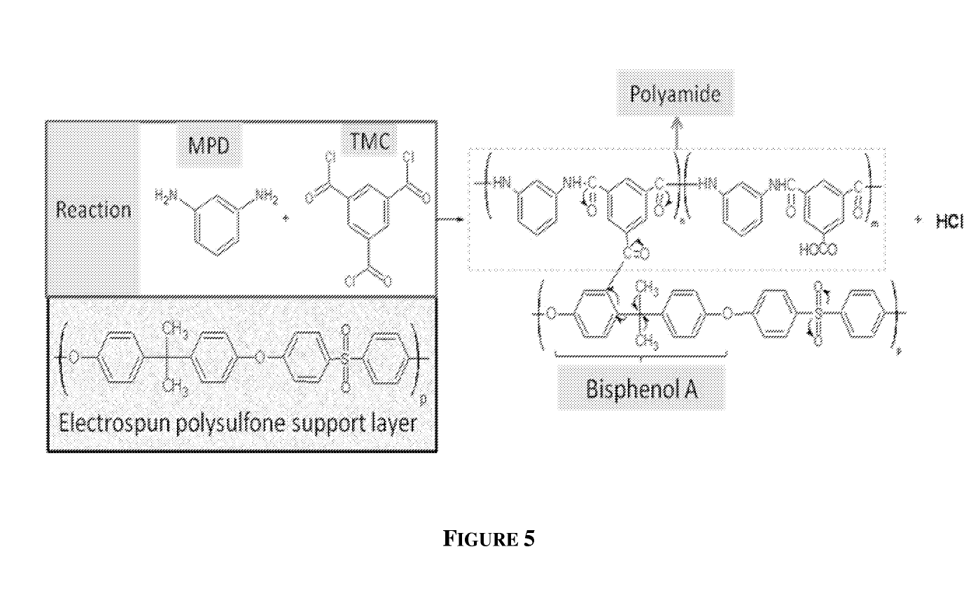

Without wishing to be bound by theory, it is believed that this moiety is likely to contribute to the relatively good adhesion between PSu and this type of polyamide, which is derived from MPD and TMC. While the —COCl functional groups in TMC play an important role in cross-linking with the amine groups in MPD, some of them do not take part into this cross-linking process. These COCl— groups can be, in part, hydrolyzed to form a carboxylic group. Noticeably, the bond C—Cl in the carbonyl groups is very weak due to the polar distribution of electrons in the structure of TMC. Therefore, it tends to be broken easily to form Cl⁻ and an electrophile of which the Carbon is the most positively charged site. This electrophile can attract an electron-rich group like —OH to form a carboxylic structure via the hydrolysis mechanism. Also, it may attack any electron-rich aromatic ring in the bisphenol A moiety of polysulfone. Meanwhile, within the structure of bisphenol A, —CH₃ is a relatively electron-releasing group. These electrons are then strongly attracted by the two aromatic rings. As a result, such a electrophile will more likely replace a hydrogen atom, which is appended to the aromatic ring at the ortho site via the electrophilic aromatic substitution mechanism or, more specifically, the Friedel-Crafts acylation mechanism [27]. This mechanism can be catalyzed by the presence of hydrochloric acid formed as a by-product of the interfacial polycondensation and the high temperature of about 95° C. at which post treatment steps occurred. A probable cross-linking interaction between polyamide skin film and polysulfone substrate has been shown in FIG. 5. It can be important to note that the yield of this proposed reaction mechanism need not be high to promote good adhesion, since the covalent bonds would be quite strong.

c. Characterization of Thin Film Composite Membrane—ATR-FTIR Spectroscopy of Uncoated Supports and PA-Coated Membranes

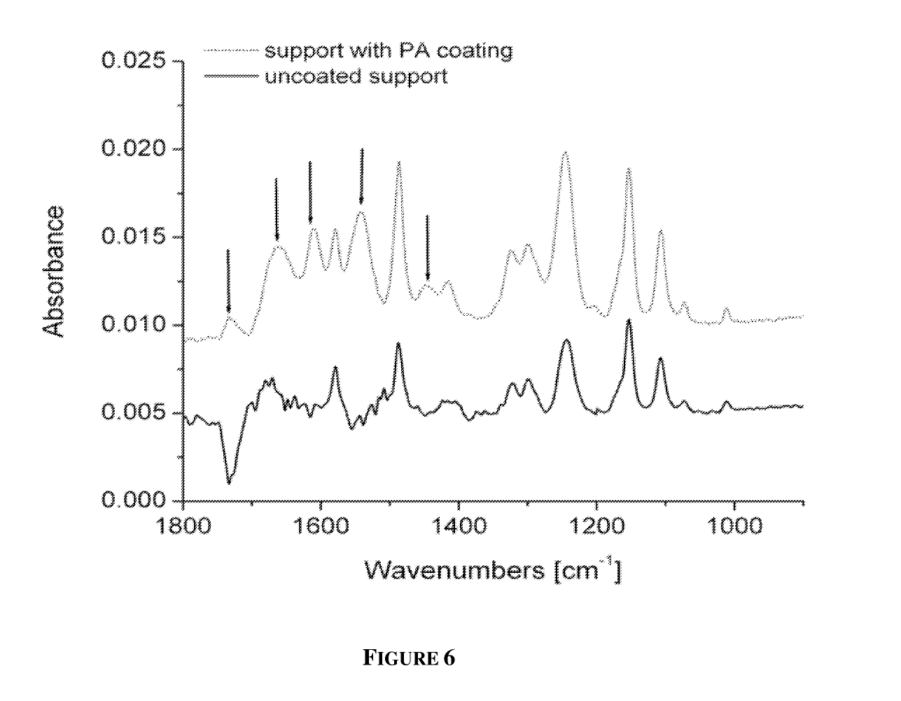

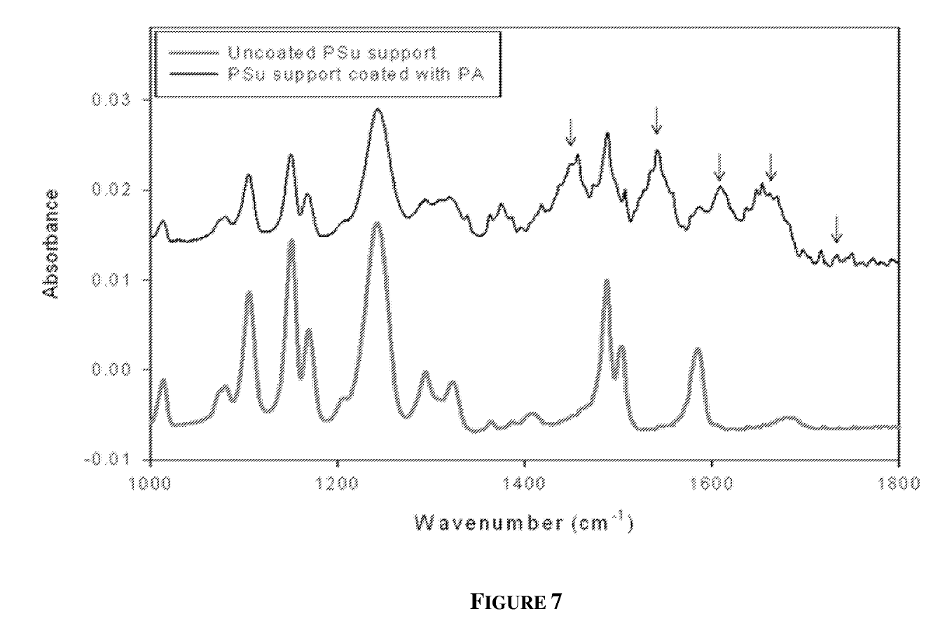

Chemical characterization of the membranes surface using attenuated total reflection Fourier-transform infrared (ATR-FTIR) is, along with SEM, useful to observe a successful coating of the polyamide skin layer atop the nonwoven PES/PSu support after the in-situ interfacial polycondensation process. FIG. 6 shows the ATR-FTIR spectra of the fingerprint region of uncoated PES support and PA-coated PES. This figure illustrates that the IR spectrum of the composite samples is composed of bands attributed to both PA film and PES scaffold. Arrows indicate peaks present in the spectrum of the composite membrane yet absent in that of the uncoated membrane. Peaks in both spectra between 1000 cm⁻¹ and 1400 cm⁻¹ are characteristic of PES support [28]. The new peaks appearing in the composite membrane are characteristic of the polyamide coating, such as peaks at 1661 cm⁻¹ (C═O of amide), 1610 cm⁻¹ (aromatic ring breathing), and 1544 cm⁻¹ (C—N stretch of amide I). Additional peaks arise in the coated membrane at 1450 cm⁻¹ and 1734 cm⁻¹ are due to the carboxylic acid groups (C—O stretching/O—H bending and C═O stretching) [16, 28]. In FIG. 7, the spectrum of the PA-coated membrane supported by PSu includes a strong band at 1650 cm⁻¹ (amide I) which is characteristic of C═O band of an amide group. Further, other bands characteristic of PA are also seen at 1610 cm⁻¹ and 1540 cm⁻¹. Table 2 provides a summary of probable assignments of IR bands for the PSu/PES-PA composite membrane surface.

TABLE 2
POSSIBLE ASSIGNMENTS OF THE IR
SPECTRA OF NEAT POLYETHERSULFONE,
POLYSULFONE SUPPORTS AND POLYAMIDE-
COATED POLYETHERSULFONE/POLYSULFONE
COMPOSITE MEMBRANES. [16, 28, 35, 36].

| | Frequency (cm⁻¹) | | |
|---|---|---|---|
| Spectra assignment | Polysulfone | Polyethersulfone | Polyamide |
| Skeletal aliphatic | | 1072, 1108 | |
| C—C/aromatic | | | |
| hydrogen | | | |
| bending/rocking | | | |
| SO₂ symmetric | | 1151 | |
| stretch | | | |
| SO₂ asymmetric | | 1294, 1325 | |
| stretch | | | |
| Aryl-O-aryl | | 1244 | |
| C—O stretch | | | |
| C═C aromatic | | 1418 | |
| ring stretching | | | |
| Characteristic | | 1486 | |
| of PES | | | |
| Skeleton aliphatic | 1014, 1080, | | |
| C—C/aromatic | 1106, 1169 | | |
| hydrogen bending, | | | |
| rocking | | | |
| C—SO₂—C | 1151 | | |
| symmetric | | | |
| stretching | | | |
| C—O—C | 1244 | | |
| stretching | | | |
| S═O stretching | 1295 | | |
| C—SO₂—C | 1323 | | |
| asymmetric | | | |
| stretching | | | |
| CH₃—C—CH₃ | 1365, 1385 | | |
| symmetric | | | |
| deformation | | | |
| C═C aromatic | 1410 | | |
| ring stretching | | | |
| CH₃—C—CH₃ | 1488 | | |
| stretching | | | |
| C═C aromatic | 1502, 1586 | | |
| ring stretching | | | |
| Carboxylic acid | | | 1450 |
| (C—O streching/ | | | |
| O—H bending) | | | |
| C—N stretch | | | 1544 |
| (amide II) | | | |
| Aromatic ring | | | 1610 |
| bending | | | |
| C═O stretching | | | 1661 |
| (amide I) | | | |
| C═O stretching | | | 1734 |
| (acid) | | | |

d. Characterization of Thin Film Composite Membrane—Focused Ion Beam Analysis on the PSU-Based TFC Membrane

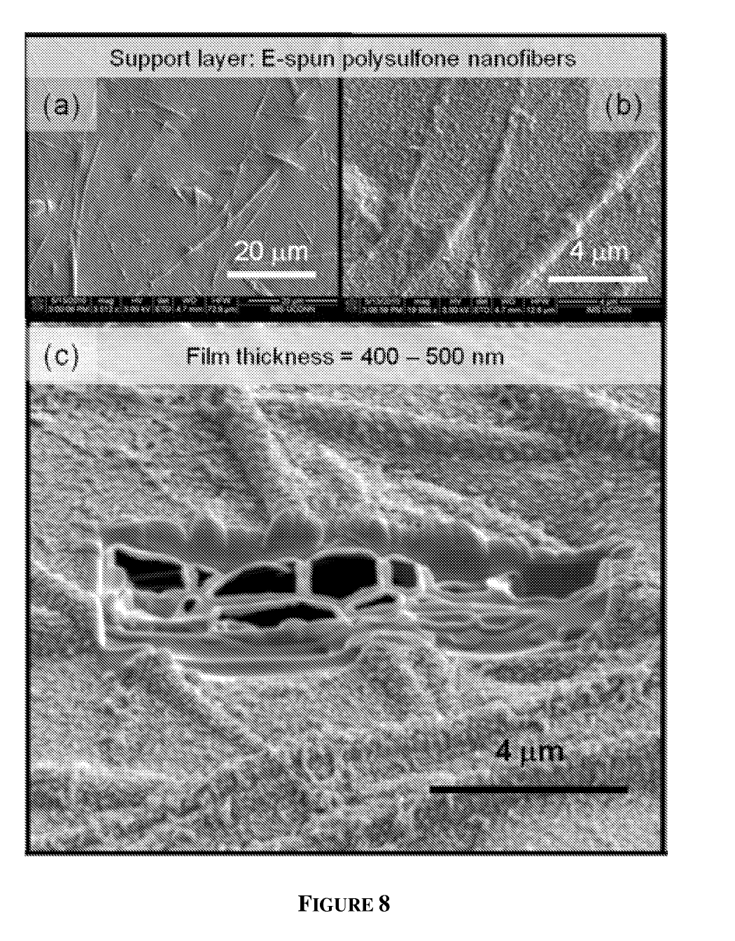

FIG. 8 provides more details regarding the distribution of the polymer phases and the porous structure of the electrospun support by employing the focused ion beam technique. Only TFC membranes supported by polysulfone were investigated in this characterization due to its better adhesion to the polyamide. By removing a part of the polyamide film, the underlying mesh of nanofibers and their junctions were exposed. From the open porous structures of the PSu layer, it is understood that there is an extremely high interfacial area between the PA skin film and the electrospun nonwoven platform. Without wishing to be bound by theory, it is believed that this may open more pathways for water and salt transportation through the membrane. The cross-sectional image in FIG. 8(c) also shows the extent that the PSu nanofibers embed themselves into the PA top layer. This is further support of the improved adhesion between the PA and PSu layers.

7. Performance of these Thin Film Composite Membrane in Direct Osmosis Tests

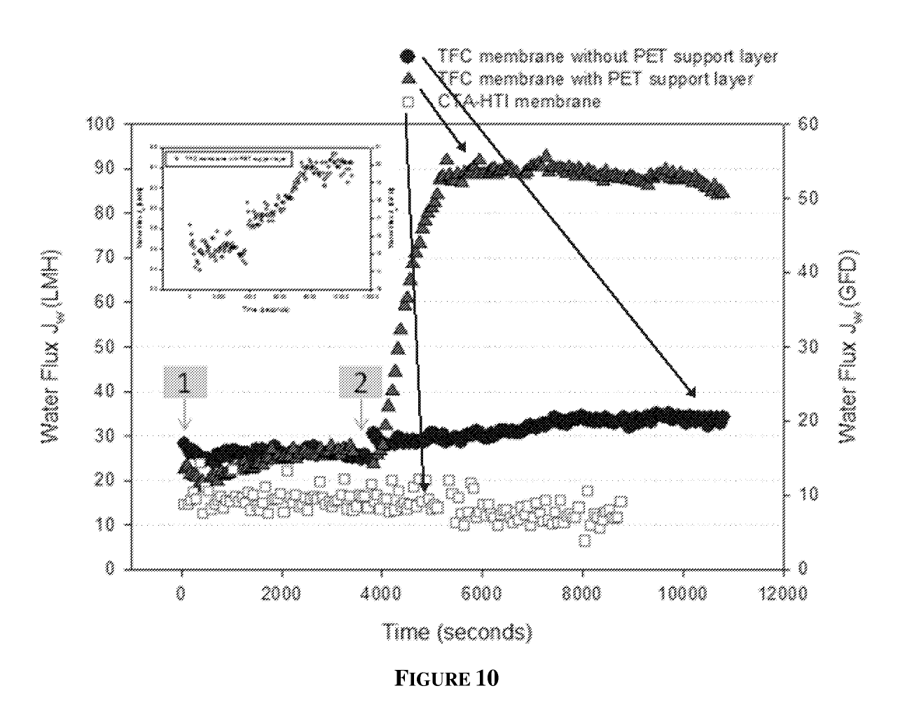

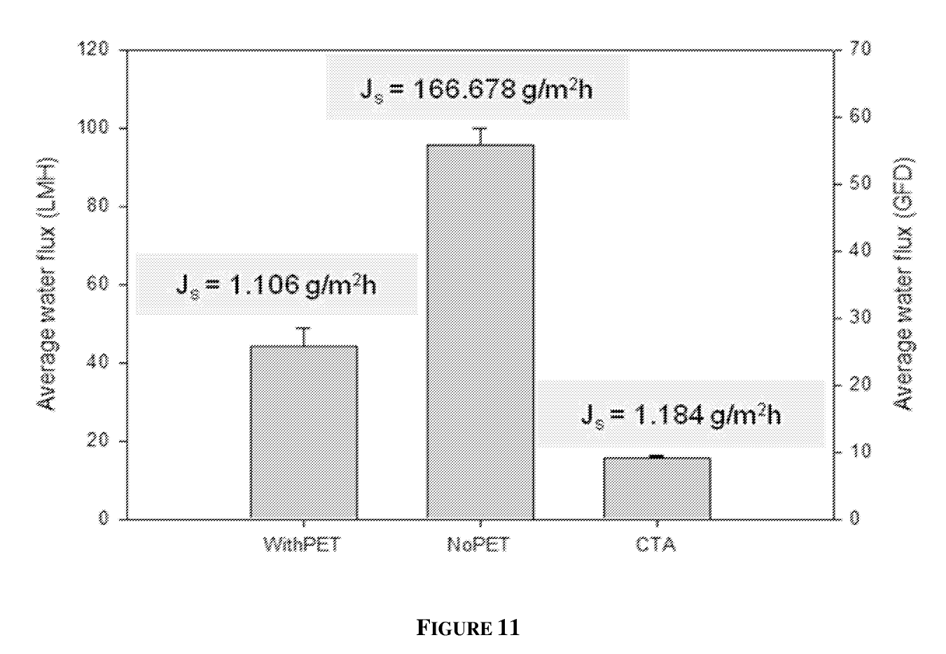

Performance of these novel TFC membranes in the direct osmosis tests (PRO mode) were illustrated in FIGS. 10 and 11. FIG. 10 shows the flux performance of the nanofiber TFC membrane with and without the PET nonwovens. NoPET and WithPET membranes with time before and after adding 1 mM aqueous solution of SDS surfactant into the feed side in DO test. Without the assistance of SDS in wetting out the support membranes, a water flux of about 25 LMH was obtained by both membranes. However, after adding SDS into the feed, the water flux through NoPET and WithPET membranes increased to about 92.2 LMH and 35.9 LMH, respectively. Without wishing to be bound by theory, it is believed that the SDS surfactant wet out the PET backing layer in a different mechanism with the PSu [17]. FIG. 11 shows water and salt flux of the NS-TFC membrane both with and without a PET nonwoven support. Comparison is made with the HTI CTA membrane. The experimental conditions follow: run in PRO mode; draw solution contained 1.5M NaCl; feed solution was deionized water; crossflow velocity of the feed and draw solution were 0.6 and 0.9 LPM, respectively; temperature of both feed and draw solutions was 23±1° C. Note that a water flux of 1 lm⁻²h⁻¹ (LMH) corresponds to 1.698 galft⁻²day⁻¹ (GFD).

It is shown in FIG. 11 that the salt flux migrating through the NoPET membrane was about two orders of magnitude higher than that through the WithPET sample which was of 166.68 g/m²h and 1.11 g/m²h, respectively. Without wishing to be bound by theory, it is believed that this is due to two reasons. First, the step can leave some defects or tiny holes on the rest part of membrane by, for example, stretching it while trying to detach those layers from each other. Second, the PA film can be, at least in part, degraded through interaction with the SDS.

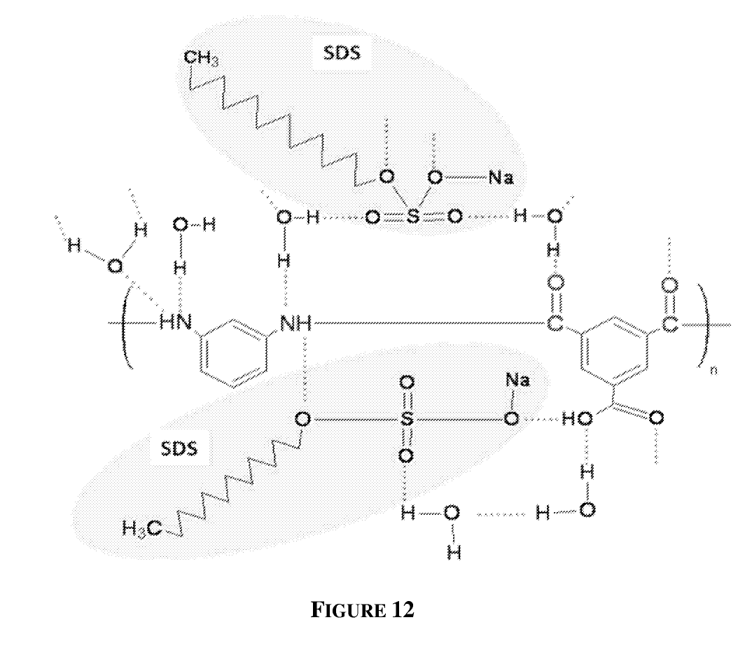

FIG. 12 illustrates a proposed mechanism of hydrogen-bonding hydration of PA in the presence of SDS and water molecules. It can be seen that both PA and SDS structures include electronegative atoms such as O and N in carbonyl, carboxylic and amine functional groups. The hydrogen-bonding acceptor and donor sites on these pertinent polar groups can create a large number of hydrogen bonds inter-molecularly and intra-molecularly. Such hydrogen bonds can be even more abundant in the presence of water molecules. Prior to contacting with water and SDS, there are hydrogen-bonded amide repeat units that are part of adjacent polyamide chains located in an amorphous domain. However, water and SDS can break weak interchain hydrogen bonds by forming hydrogen bonds with these amide groups. By introduction into the polyamide matrix via hydrogen-bonding, water and SDS can plasticize the amorphous portion of the polyamide network, thus allowing the chain segments to slip to each other, thereby opening the network and lowering the glass transition temperature T_{g [}29] below the temperature of the swelling measurements [30]. Without wishing to be bound by theory, it is believed that hydrogen bonding is one of the factors giving rise to negative Flory interaction parameter X values and to greatly increased swelling of polar polymers in [30-32]. Moreover, as discussed in [33], the presences of small cations and anions in the solvents (e.g., water) can cause stabilization and destabilization of the hydrogen-bonding hydration through ionic hydration. Therefore, as one of various stimuli-induced swelling behaviors, ion-specific swelling behavior observed for polymer gels in aqueous system should not be neglected [33]. In the circumstance of using SDS as a wetting assistance in direct osmosis running in PRO mode, the presence of small cation Na⁺ and small anion Cl⁻ may need to be taken into consideration of the stabilization and destabilization of hydrogen-bonding hydration of polar polymers. As a consequence, the swelling of polar polyamide skin layer may be difficult to avoid in the presence of stimuli like SDS, NaCl, and aqueous solvent. Without wishing to be bound by theory, it is believed that the swelling degree of the skin layer first occurs at the edge of the membrane and gradually develops into its bulk after certain time of water transporting continuously through the membrane.

Thus, the experiments were intentionally set up in a way that this surfactant is added into the feed to not only wet out the supports, but also to prevent SDS from coming into contact with the PA selective layer. Nonetheless, as the supports are porous, it can be difficult to inhibit diffusion or drag of SDS molecules through the pores. This phenomenon can become severe if PET is omitted and the SDS is exposed freely to the open porous structure of electrospun PSu substrate. Consequently, more salt molecules can migrate through the selective layer after the PA film was swollen, thereby increasing conductivity of the feed solution, especially when the PET backing layer was removed.

Table 3 summarizes the performance of commercial CTA membrane and hand-casted TFC polyamide supported with electrospun nonwoven nanofibers membrane with and without using wetting agent SDS. There are only minor difference in the average flux through membranes with and without PET backing layers before wetting the supports with SDS. However, with the assistance of SDS, the average flux increased to 86.09 LMH for membrane only supported with PSu (e.g., NoPET sample), while slightly increased to 33.59 LMH for the WithPET sample. The average apparent osmotic water permeability and solute permeability coefficients Ā and B̅ were also shown in this table. Without wishing to be bound by theory, it is believed that both A and the ratio A/B are desired to be maximized [34]. Though having lower osmotic water flux than the NoPET sample, the WithPET sample possesses a much higher A/B ratio, which was about 1.71 kPa⁻¹. Furthermore, the apparent A coefficient determined in table 2 is actually significantly less than the actual A coefficient, due to the fact that the effective osmotic driving force is much less than the apparent driving force caused by dilutive external concentration polarization on the draw side of the membrane. It is thus expected that the actual A/B value of this membrane is even higher than 1.71 kPa⁻¹. Also, an osmotic water flux of 33.59 LMH demonstrates that lab-made PSu-PET-supported TFC polyamide membranes are superior to literature-reported all flat-sheet FO membranes. The average osmotic water flux through the commercial CTA membrane in the same direct osmosis testing conditions was only about 15.51 LMH, while the reverse salt leakage, although this membrane was about the same as with PET sample.

TABLE 3
LAB-MADE TFC POLYAMIDE MEMBRANE
SEPARATION PERFORMANCE

| | | | | Average | Average | |
|---|---|---|---|---|---|---|
| | | | | osmotic | osmotic | |
| | | Steady-state | | water | solute | |
| | | average water | | permeability | permeability | |
| | | flux | | Ā⁽¹⁾ | coefficient B̅⁽²⁾ | |
| | | (LMH) | (GFD) | (m/kPa · s) | (m/s) | A/B |
| With | Before | 25.99 | 15.29 | 9.49E−10 | 5.55E−10 | 1.709 |
| PET | adding | | | | | |
| | SDS | | | | | |
| | After | 33.59 | 19.76 | 1.17E−09 | 6.85E−10 | |
| | adding | | | | | |
| | SDS | | | | | |
| No | Before | 23.98 | 14.11 | 8.75E−10 | 3.08E−08 | 0.028 |
| PET | adding | | | | | |
| | SDS | | | | | |
| | After | 86.09 | 50.64 | 3.22E−09 | 1.14E−07 | |
| | adding | | | | | |
| | SDS | | | | | |
| CTA | No SDS | 15.51 | 9.13 | 4.79E−10 | 2.34e−10 | 2.045 |

⁽¹⁾Intrinsic water permeability A was determined from the volumetric flux through the membrane, J_{w}, measured for the osmotic pressure (Δπ): A = J_{w}/Δπ
⁽²⁾Solute permeability coefficient B was derived from the water flux and the observed solute rejection Rₛ, B = J_{w}(1 − Rₛ)/Rₛ, where Rₛ = (1 − Cₚ/C_{f}), Cₚ and C_{f} was interpolated from the conductivity-concentration curve of NaCl solutions.

As described herein, a novel asymmetric thin film composite membrane was for the first time successfully fabricated for engineered osmosis process using an electrospun nanofiber nonwoven support layer which uniquely possesses a thin film thickness, high porosity and low tortuosity. The internal polarization concentration is therefore very desirable to be alleviated by applying this novel TFC membrane. The fabrication was basically a two-step preparation—an electrospinning process for the thin and porous support followed by an in-situ interfacial polymerization for the polyamide film. The ultrathin polyamide selective layer was well-coated on the top of the nanofibrous scaffold. Early test results with these novel membranes under direct osmosis conditions (in PRO mode) were very promising. Very high water flux of about 92.2 LMH and an acceptable salt flux were achieved with TFC membranes without PET backing layer. Especially, for TFC membranes with PET substrates, the water flux can be obtained at 35.9 LMH with a reverse salt leakage of as small as 1.11 g/m²h. These membranes possess a desirably high ratio of A/B. Though further optimization is necessary, this unique approach of tailoring membrane has shown promise as being an excellent alternative to RO membranes for EO processes.

### G. REFERENCES

1. McCutcheon, J. R. and M. Elimelech, Influence of concentrative and dilutive internal concentration polarization on flux behavior in forward osmosis. Journal of Membrane Science, 2006. 284: p. 237-247.
2. Gray, G. T., J. R. McCutcheon, and M. Elimelech, Internal concentration polarization in forward osmosis: role of membrane orientation. Desalination, 2006. 197: p. 1-8.
3. Cadotte, J. E., Reverse osmosis membrane, in U.S. patent documents. 1977: U.S.
4. Lind, M. L., et al., Influence of Zeolite Crystal Size on Zeolite-Polyamide Thin Film Nanocomposite Membranes. Langmuir, 2009. 25(17): p. 10139-10145.
5. Mukherjee, D., A. Kulkarni, and W. N. Gill, Chemical treatment for improved performance of reverse osmosis membranes. dESALINATION, 1996. 104: p. 239-249.
6. Hirose, M., H. Ito, and Y. Kamiyama, Effect of skin layer surface structures on the flux behavior of RO membranes. Journal of Membrane Science, 1996. 121: p. 209-215.
7. Roh, I. J., et al., Effects of the Polyamide Molecular Structure on the Performance of Reverse Osmosis Membranes. Journal of Polymer Science: Part B: Polymer Physics, 1998. 36: p. 1821-1830.
8. Kulkarni, A., D. Mukherjee, and W. N. Gill, Flux enhancement by hydrophilization of thin film composite reverse osmosis membranes. Journal of Membrane Science, 1996. 114: p. 39-50.
9. Ghosh, A. K., et al., Impacts of reaction and curing conditions on polyamide composite reverse osmosis membrane properties. Journal of Membrane Science, 2008. 311: p. 34-45.
10. Ghosh, A. K. and E. M. V. Hoek, Impacts of support membrane structure and chemistry on polyamide-polysulfone interfacial composite membranes. Journal of Membrane Science, 2009. 336: p. 140-148.
11. Jeong, B.-H., et al., Interfacial polymerization of thin film nanocomposites: A new concept for reverse osmosis membranes. Journal of Membrane Science, 2007. 294: p. 1-7.
12. Song, Y., et al., Mechanisms of structure and performance controlled thin film composite membrane formation via interfacial polymerization process. Journal of Membrane Science, 2005. 251: p. 67-79.
13. Freger, V., J. Gilron, and S. Belfer, TFC polyamide membranes modified by grafting of hydrophilic polymers: an FT-IR/AFM/TEM study. Journal of Membrane Science, 2002. 209: p. 283-292.
14. Belfer, S., et al., Surface modification of commercial composite polyamide reverse osmosis membranes. Journal of Membrane Science, 1998. 139: p. 175-181.
15. Kim, H. I. and S. S. Kim, Plasma treatment of polypropylene and polysulfone supports for thin film composite reverse osmosis membrane. Journal of Membrane Science, 2006. 286: p. 193-201.
16. Rao, A. P., et al., Structure-performance correlation of polyamide thin film composite membranes: effect of coating conditions on film formation. Journal of Membrane Science, 2003. 221(1): p. 13-24.
17. McCutcheon, J. R. and M. Elimelech, Influence of membrane support layer hydrophobicity on water flux in osmotically driven membrane processes. Journal of Membrane Science, 2008. 318: p. 458-166.
18. Loeb, S., et al., Effect of porous support fabric on osmosis through a Loeb-Sourirajan type asymmetric membrane. Journal of Membrane Science, 1997. 129: p. 243-249.
19. Cath, T. Y., A. E. Childress, and M. Elimelech, Forward osmosis: Principles, applications, and recent developments. Journal of Membrane Science, 2006. 281: p. 70-87.
20. Tan, C. H. and H. Y. Ng, Modified models to predict flux behavior in forward osmosis in consideration of external and internal concentration polarizations. Journal of Membrane Science, 2008. 324: p. 209-219.
21. Lee, K. L., R. W. Baker, and H. K. Lonsdale, Membranes for power generation by pressure-retarded osmosis. Journal of Membrane Science, 1981. 8: p. 141-171.
22. Wang, R., et al., Characterization of novel forward osmosis hollow fiber membranes. Journal of Membrane Science, 2010. 355: p. 158-167.
23. Yang, Q., K. Y. Wang, and T.-S. Chung, Dual-layer hollow fibers with enhanced flux as novel forward osmosis membranes for water production. Environ. Sci. Technol., 2009. 43: p. 2800-2805.
24. Wang, K. Y., et al., Enhanced forward osmosis from chemically modified polybenzimidazole (PBI) nanofiltration hollow fiber membranes with a thin wall. Chemical Engineering Science, 2009. 64: p. 1577-1584.
25. Yip, N. Y., et al., High Performance Thin-Film Composite Forward Osmosis Membrane. Environ. Sci. Technol., 2010. 44: p. 3812-3818.
26. Tang, Z., et al., Design and Fabrication of Electrospun Polyethersulfone Nanofibrous Scaffold for High-Flux Nanofiltration Membranes. Journal of Polymer Science: Part B: Polymer Physics, 2009. 47: p. 2288-2300.
27. L. J. Wade, J., Reactions of Aromatic Compounds, in Organic Chemistry 5th edition. 2003, Pearson Education, Inc.: Upper Saddle River, N.J. p. 747.
28. Singh, P. S., et al., Probing the structural variations of thin film composite RO membranes obtained by coating polyamide over polysulfone membranes of different pore dimensions. Journal of Membrane Science, 2006. 278: p. 19-25.
29. Hirai, N., The Gel-Elasticity of High Polymers. 1955, Goto Laboratory. p. 21-37.
30. Schott, H., Kinetics of swelling of polymers and their gels. Journal of Pharmaceutical Sciences, 1992. 81(5): p. 467-470.
31. Flory, P. J., Principles of polymer chemistry. 1953, Ithaca, N.Y.: Cornell University Press.
32. Tsuk, A. G. and H. P. Gregor, Oleophilic Ion-exchange Polymers. II. Swelling of Cross-Linked Networks with Multiple Hetero Side Chains. Journal of American Chemical Society 1965. 87(24): p. 5534-5537.
33. Muta, H., M. Miwa, and M. Satoh, Ion-specific swelling of hydrophilic polymer gels. Polymer, 2001. 42: p. 6313-6316.
34. Lonsdale, H. K., Recent advances in reverse osmosis membranes. Desalination, 1973. 13(3): p. 317-332.
35. Salgin, S., S. Takaç, and T. H. Özdamar, Effect of ionic environments on the adsorption and diffusion characteristics of serine alkaline protease enzyme in polyethersulfone ultrafiltration membranes. Journal of Colloid and Interface Science, 2006. 299: p. 806-814.
36. Polymer Data Handbook, ed. J. E. Mark. 1999: Oxford University Press.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A semi-permeable nanostructured osmosis membrane comprising a film polymerized on a nanofiber support fabric.

2. The membrane of claim 1, wherein the nanofiber support fabric comprises polyethersulfone.

3. The membrane of claim 1, wherein the nanofiber support fabric is electrospun.

4. The membrane of claim 1, wherein the nanofiber support fabric is nonwoven.

5. The membrane of claim 1, wherein the film comprises at least one of a polyamide, a polyether, a polyether-urea, a polyester, or a polyimide or a copolymer thereof or a mixture thereof.

6. The membrane of claim 1, wherein the film comprises a polyamide.

7. The membrane of claim 6, wherein the polyamide comprises residues of a phthaloyl halide, a trimesyl halide, or a mixture thereof.

8. The membrane of claim 6, wherein the polyamide comprises residues of diaminobenzene, triaminobenzene, or piperazine or a mixture thereof.

9. The membrane of claim 6, wherein the film comprises an aromatic polyamide.

10. The membrane of claim 1, wherein the film comprises residues of a trimesoyl halide and residues of a diaminobenzene.

11. The membrane of claim 1, wherein the film has an average thickness of from about 50 nm to about 500 nm, from about 200 nm to about 300 nm, or from about 50 nm to about 200 nm.

12. The membrane of claim 1, wherein the nanofiber support fabric comprises nonwoven, electrospun polyethersulfone.

13. The membrane of claim 1, wherein the film comprises an interfacially polymerized aromatic polyamide.

14. The membrane of claim 1, wherein the film is an aromatic polyamide interfacially polymerized onto a nonwoven, electrospun polyethersulfone nanofiber support fabric.

15. The membrane of claim 1, wherein the film and/or the nanofiber support fabric further comprise particles.

16. The membrane of claim 15, wherein the particles are nanoparticles.

17. The membrane of claim 16, wherein the nanoparticles are hydrophilic nanoparticles.

18. The membrane of claim 16, wherein the nanoparticles comprise preferential flow paths.

19. The membrane of claim 16, wherein the nanoparticles have an average hydrodynamic diameter of from about 10 nm to about 1000 nm, from about 50 nm to about 500 nm, from about 50 nm to about 200 nm, or from about 200 nm to about 300 nm.

20. The membrane of claim 16, wherein the nanoparticles comprise a mesoporous molecular sieve comprising at least one of an oxide of aluminum, titanium or silicon, an aluminosilicate, titanosilicate or an aluminophosphate or a mixture thereof.

21. The membrane of claim 16, wherein the nanoparticles comprise at least one zeolite.

22. The membrane of claim 16, wherein the nanoparticles comprise Zeolite A.

23. A nanostructured osmosis membrane comprising a polymer film and a nanofiber support fabric, and not comprising a macroscale support membrane.

24. A method for preparing a semi-permeable nanostructured osmosis membrane, the method comprising polymerizing a film onto a nanofiber support fabric.

25. The method of claim 24, wherein polymerizing is performed interfacially.

26. The method of claim 24, wherein the nanofiber support fabric comprises polyethersulfone.

27. The method of claim 24, wherein the nanofiber support fabric is electrospun.

28. The method of claim 24, wherein the nanofiber support fabric is nonwoven.

29. The method of claim 24, wherein the film comprises at least one of a polyamide, a polyether, a polyether-urea, a polyester, or a polyimide or a copolymer thereof or a mixture thereof.

30. The method of claim 24, wherein the film comprises a polyamide.

31. The method of claim 24, wherein the film further comprises particles.

32. The method of claim 24, wherein the film further comprises nanoparticles.

33. The product produced by the method of claim 24.

34. A method for osmotically-driven separation, the method comprising creating an osmotic pressure gradient across a semi-permeable nanostructured osmosis membrane comprising a film polymerized on a nanofiber support fabric.

35. The method of claim 34, wherein the semi-permeable nanostructured osmosis membrane exhibits a water permeability of more than 100× that of a commercial “CTA” membrane.

36. The method of claim 34, wherein the semi-permeable nanostructured osmosis membrane exhibits a salt passage of more than 100× that of a commercial “CTA” membrane.

37. The method of claim 34, wherein purified water is produced.

38. The method of claim 34, wherein electricity is produced.
